(19) United States
(12) Patent Application Publication
(10) Pub. No.: US 2026/0361580 A1
(43) Pub. Date: Nov. 12, 2026

(54) SPINAL CODING USING A RANDOMIZED INITIAL STATE

(71) Applicant: QUALCOMM Incorporated, San Diego, CA (US)

(72) Inventors: Matan GUETTA, San Diego, CA (US); Thomas Joseph RICHARDSON, South Orange, NJ (US); Wei YANG, San Diego, CA (US); Peer BERGER, Hod Hasharon (IL)

(21) Appl. No.: 19/201,362

(22) Filed: May 7, 2025

(51) Int. Cl. H04L 27/26; G06F 7/58; H04L 1/00

(52) U.S. Cl. CPC H04L 27/2605; G06F 7/58; H04L 1/0003

(57) ABSTRACT

Aspects of the present disclosure relate generally to implementing spinal coding using a randomized initial state. For example, a wireless communications device may, as part of a spinal encoding process, generate a randomized initial v-bit state in accordance with a randomization seed. The wireless communications device may then generate a sequence of sets of one or more constellation symbols from the randomized initial v-bit state and transmit one or more communications according to the sequence of sets of one or more constellation symbols.

### FIELD OF THE DISCLOSURE

Aspects of the present disclosure generally relate to wireless communication and specifically relate to techniques, apparatuses, and methods for spinal coding using a randomized initial state.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communications devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communications devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In a wireless communication system, the transmission of information is said to occur through a communication channel, referred to simply as a “channel.” A transmitted signal (x) may experience a channel effect (often denoted H, where H is a channel matrix that represents the channel effect). At a receiver, a received signal may include the transmitted signal (x) as transformed by the channel effect, plus noise (z, sometimes denoted n):

y=Hx+z

Thus, the transmitted signal is transformed and corrupted by both the channel's inherent characteristics and by random noise sources, leading to information loss or distortion.

Channel coding addresses these challenges. Channel coding includes techniques for improving the reliability of communications via a wireless channel. For example, some forms of channel coding may provide structured redundancy and error-correction mechanisms. Some channel coding approaches include block codes and convolutional codes, which provide for the addition of redundant bits to an input communication or signal.

### SUMMARY

Certain aspects provide a method of wireless communication by a wireless communications device. The method includes generating a randomized initial v-bit state in accordance with a randomization seed; generating a sequence of v-bit states, each v-bit state in the sequence of v-bit states being generated in accordance with a respective set of k information bits in a sequence of sets of k information bits and in accordance with a respective preceding v-bit state in the sequence of v-bit states, except that a first v-bit state in the sequence of v-bit states is generated in accordance with a first set of k information bits in the sequence of sets of k information bits and the randomized initial v-bit state; generating a sequence of c-bit values, each c-bit value of the sequence of c-bit values being generated in accordance with a pseudorandom number generator and a respective v-bit state in the sequence of v-bit states; mapping the sequence of c-bit values to a sequence of sets of one or more constellation symbols; and transmitting one or more communications according to the sequence of sets of one or more constellation symbols.

Certain aspects provide a method of wireless communication by a wireless communications device. The method includes generating a plurality of sets of candidate constellation symbols based at least in part on a plurality of candidate randomization seeds, wherein each set of candidate constellation symbols of the plurality of sets of candidate constellation symbols corresponds to a different candidate randomization seed of the plurality of candidate randomization seeds; selecting a randomization seed, from the plurality of candidate randomization seeds, based at least in part on the plurality of sets of candidate constellation symbols; and transmitting an indication of the selected randomization seed.

Aspects of the present disclosure may generally be implemented by or as a method, apparatus, system, computer program product, non-transitory computer-readable medium, user equipment, base station, network node, network entity, wireless communications device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network entity architecture.

FIG. 3 depicts aspects of network entities and a user equipment (UE).

FIG. 4 is a diagram illustrating an example associated with encoding of spinal codes in accordance with the present disclosure.

FIG. 5 is a diagram illustrating an example associated with a puncturing scheme for spinal codes in accordance with the present disclosure.

FIG. 6 is a diagram illustrating an example of signaling associated with spinal coding using a randomized initial state.

FIG. 7 is a diagram illustrating an example of spinal coding using a randomized initial state.

FIG. 8 is a diagram illustrating an example of spinal coding using a randomized initial state and code block segmentation for segmenting a code block into multiple sub-code-blocks.

FIG. 9 shows a method for wireless communication by a wireless communications device.

FIG. 10 depicts aspects of an example communications device configured for wireless communications.

FIG. 11 shows a method for wireless communication by a wireless communications device.

FIG. 12 depicts aspects of an example communications device configured for wireless communications.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A spinal code can be used to implement rateless coding or can be used to implement fixed rate coding. In some scenarios, spinal codes can be implemented to handle time-varying channel conditions without explicit bit rate selection. For example, spinal coding can be implemented to enable transmission at a higher rate than a channel can sustain, followed by iterative re-transmission of information bits to lower the effective rate until a decoding success occurs (for example, until the receiver transmits an acknowledgment (ACK) or a negative acknowledgment (NACK)). More specifically, a transmitting device may perform the encoding once, and the channel rate may be changed based at least in part on the total quantity of channel uses (for example, a total quantity of times a communication channel is utilized to transmit information, which, in some examples, corresponds to a total quantity of resource elements). By contrast, in other coding schemes, changing the channel rate is considered to be part of re-encoding the data.

In spinal coding, input data is broken down into multiple segments of information bits, and each of these segments of information bits is sequentially processed to generate a respective spinal symbol. Each spinal symbol is mapped to (for example, converted to or treated as) one or more modulation symbols and transmitted. A hash function h is used in association with generating a given spinal symbol. More particularly, a wireless communications device may generate a sequence of v-bit states. H ere, each v-bit state in the sequence of v-bit states is generated based on the hash function h in accordance with a respective set of k information bits, in a sequence of sets of k information bits, and based on a preceding v-bit state in the sequence of v-bit states (except that a first v-bit state is generated based on an initial v-bit state). The wireless communications device may then generate a sequence of c-bit values in accordance with a pseudorandom number generator (for example, a random number generator (RNG)) and the sequence of v-bit states. The wireless communications device may then map the sequence of c-bit values to a sequence of sets of one or more constellation symbols, and may transmit one or more communications according to the sequence of sets of one or more constellation symbols.

A conventional spinal encoding scheme uses an initial v-bit state of zero (for example, an initial v-bit state of zero (S₀=0)). Setting the initial v-bit state to zero can degrade randomization of symbols generated by the spinal coding procedure. For example, a goal for a spinal coding procedure (and other coding procedures) is to transmit random symbols on a channel so as to be close as possible to the Shannon limit—the theoretical upper bound on the amount of information that can be transmitted reliably through the channel. Setting the initial v-bit state to zero degrades randomness in that some symbols in a sequence of v-bit states (for example, earlier v-bit states in the sequence of v-bit states) may have degraded randomness. For example, the hash function h receives two inputs—a v-bit state and a set of k information bits. In one example, if an initial v-bit state is set to zero and the set of information bits comprise two information bits (that is, k=2), then there are only four options at an output of the hash function h, meaning that there may be degraded randomness that inhibits reaching the Shannon limit. The degraded randomness caused by setting the initial v-bit state to zero is particularly problematic for shorter code blocks (e.g., code blocks having al length in range from approximately 32 bits to approximately 512 bits) because, for example, there are fewer symbols generated for shorter code blocks. The degraded randomness caused by setting the initial v-bit state to zero may cause, for example, a block error rate (BLER) to move away from the Shannon limit and, similarly, an inconsistency of the BLER (for example, such that a BLER curve over a signal-to-noise ratio (SNR) range is rough or unstable).

Aspects of the present disclosure relate generally to generating a randomized initial v-bit state based on a randomization seed. In some aspects, the use of the randomized initial v-bit state in the spinal coding procedure increases randomness of constellation symbols generated by the spinal coding procedure. In this way, the randomized initial v-bit state may serve to enable a BLER achieved by the spinal coding procedure to move closer to the Shannon limit and to increase consistency of the BLER achieved by the spinal coding procedure (as compared to setting the initial v-bit state to zero).

Aspects of the present disclosure may be used to realize one or more of the following potential advantages. In some aspects, by generating the initial v-bit state (e.g., based on a hash function h) in accordance with the randomization seed, the techniques and apparatuses enable spinal coding to be implemented using a randomized initial v-bit state, which serves to allow a BLER achieved by the spinal coding procedure to move closer to the Shannon limit and to increase consistency of the BLER achieved by the spinal coding procedure.

In some aspects, the techniques and apparatuses depicted and described may be particularly useful for a spinal coding procedure that uses code block segmentation for segmenting a code block into multiple (shorter) sub-code-blocks to simplify encoder and decoder implementation and reduce complexity of a multiple input multiple output (MIMO) spinal code decoder. The techniques and apparatuses depicted and described enhance performance of a spinal coding procedure that uses code block segmentation by, for example, increasing randomness that would be otherwise degraded due to the segmentation of code blocks into shorter sub-code-blocks.

Further, while the techniques and apparatuses depicted and described here are described with respect to a spinal coding procedure, these techniques and apparatuses may be applicable to another type of coding procedure, such as any type of coding procedure having a structure similar to that of spinal coding that incorporates incremental randomness.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communications devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communications devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIM), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

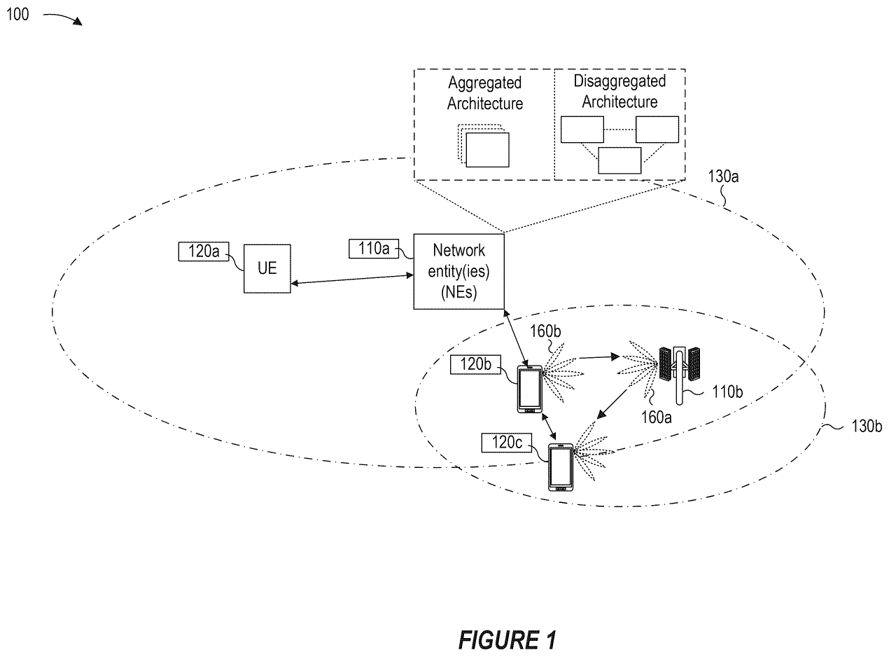

FIG. 1 is a diagram illustrating an example of a wireless communication network 100. The wireless communication network 100 may be or may include elements of a 5G network or a 6G network, among other examples. The wireless communication network 100 may include multiple network entities 110. For example, in FIG. 1, the wireless communication network 100 includes a network entity (NE) 110a and a network entity 110b. The network entities 110 may support communications with multiple UEs 120. For example, in FIG. 1, the network entities 110 support communication with a UE 120a, a UE 120b, and a UE 120c. In some examples, a UE 120 may also communicate with other UEs 120 and a network entity 110 may communicate with a core network and with other network entities 110.

The network entities 110 and the UEs 120 of the wireless communication network 100 may communicate using the electromagnetic spectrum, which may be subdivided into various licensed or unlicensed operating bands, frequency ranges, component carriers, or channels that define associated frequencies available for communications. In some examples, each of the network entities 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network entity 110 may be, may include, or may also be referred to as an NR network entity, a 5G network entity, a 6G network entity, a Node B, a gNB, an access point (AP), a transmission reception point (TRP), a network entity, a network element, a network equipment, and/or another type of device, component, or system included in a RAN. In various deployments, a network entity 110 may be implemented as a single physical node (for example, a single physical structure) or may be implemented as two or more physical nodes (for example, two or more distinct physical structures). For example, a network entity 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network entity 110 may be an aggregated network entity having an aggregated architecture, meaning that the network entity 110 may implement a full radio protocol stack that is physically and logically integrated within a single physical structure in the wireless communication network 100. For example, an aggregated network entity 110 may consist of a single standalone base station or a single TRP that operates with a full radio protocol stack to enable or facilitate communication between a UE 120 and a core network of the wireless communication network 100.

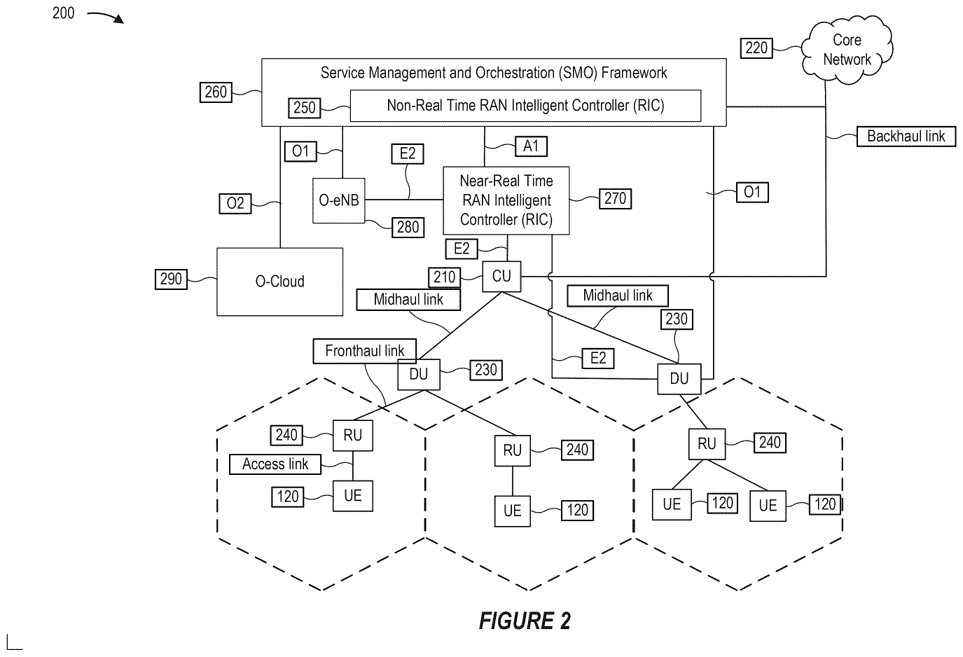

Alternatively, and as also shown, a network entity 110 may be a disaggregated network entity (sometimes referred to as a disaggregated base station), having a disaggregated architecture, meaning that the network entity 110 may operate with a radio protocol stack that is physically distributed and/or logically distributed among two or more nodes in the same geographic location or in different geographic locations. An example disaggregated network entity architecture is described in more detail below with reference to FIG. 2. In some deployments, disaggregated network entities 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network entities 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network entity 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network entities 110 (for example, a base station, an RU, or a TRP) may provide communication coverage for a particular geographic area. The term “cell” can refer to a coverage area of a network entity 110 or to a network entity 110 itself, depending on the context in which the term is used. A network entity 110 may support one or more cells (for example, each cell may support communication within an angular (for example, 60 degree) range around the network entity). In some examples, a network entity 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network entity 110 (for example, a train, a satellite, an unmanned aerial vehicle, or an NTN network entity).

The wireless communication network 100 may be a heterogeneous network that includes network entities 110 of different types, such as macro network entities, pico network entities, femto network entities, relay network entities, aggregated network entities, and/or disaggregated network entities, among other examples. Various different types of network entities 110 may generally transmit at different power levels, serve different coverage areas (for example, a cell 130a and a cell 130b), and/or have different impacts on interference in the wireless communication network 100 than other types of network entities 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communications device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global N avigation Satellite System (GNSS) device (such as a Global Positioning System device or another type of positioning device), a UE function of a network entity, and/or any other suitable device or function that may communicate via a wireless medium.

In some examples, a network entity 110 may be, may include, or may operate as an RU, a TRIP, or a base station that communicates with one or more UEs 120 via a radio access link (which may be referred to as a “Uu” link). The radio access link may include a downlink and an uplink. “Downlink” (or “DL”) refers to a communication direction from a network entity 110 to a UE 120, and “uplink” (or “UL”) refers to a communication direction from a UE 120 to a network entity 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

In some examples, a UE 120 and a network entity 110 may perform MIMO communication. MIMO communication generally refers to transmitting or receiving multiple signals (such as multiple layers or multiple data streams) simultaneously over the same time and frequency resources. A network entity 110 or a UE 120 may communicate using single-user MIMO or multi-user MIMO (MU-MIMO), the latter of which being used by a network entity 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network entity 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network entity 110 or a UE 120 may implement massive MIMO, which may be associated with an increased (for example, “massive”) quantity of antennas at the network entity 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network entity 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network entity 110 transmitting signals (for example, SSBs or other signals) via respective beams (for example, of the beams 160 of the network entity 110) and the UE 120 receiving and measuring the signal(s) via respective beams of multiple beams (for example, from the beams 160 of the UE 120) to identify a best beam (or beam pair) for communication between the UE 120 and the network entity 110. A beam refinement operation may involve a first device (for example, the UE 120 or the network entity 110) transmitting signal(s) via a subset of beams (for example, identified based on, or otherwise associated with, measurements reported as part of one or more other beam management operations). A second device (for example, the network entity 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QC L) parameter, among other examples.

FIG. 2 is a diagram illustrating an example disaggregated network entity architecture 200. One or more components of the example disaggregated network entity architecture 200 may be, may include, or may be included in one or more network entities (such one or more network entities 110). The disaggregated network entity architecture 200 may include a CU 210 that can communicate directly with a core network 220 via a backhaul link, or that can communicate indirectly with the core network 220 via one or more disaggregated control units, such as a Non-RT RAN intelligent controller (RIC) 250 associated with a Service Management and Orchestration (SMO) Framework 260 and/or a Near-RT RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network entity architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PH Y layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, artificial intelligence or machine learning (AI/ML) workflows including model training and updates, and/or policy-based guidance of applications and/or features in the Near-RT RIC 270. The N on-RT RIC 250 may be coupled to or may communicate with (such as via an AI interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the N on-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

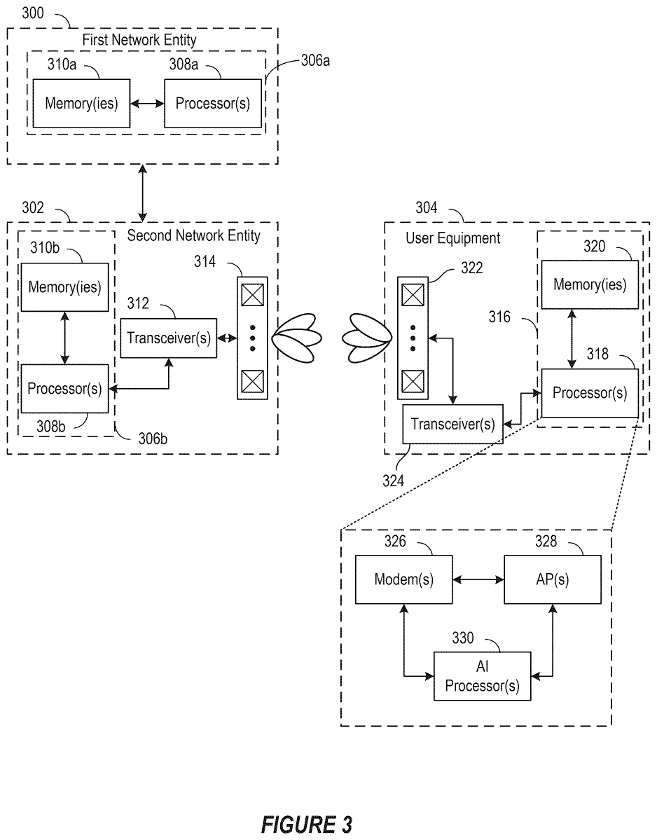

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (for example, network entity 110). For example, first network entity 300 and second network entity 302 may be co-located. In some other examples, first network entity 300 may be implemented separately from second network entity 302. For example, first network entity 300 may be implemented as a function (for example, one or more processes) running on a server, such as in a cloud (for example, a public or private cloud). As another example, first network entity 300 may be implemented as a virtual computing instance (for example, virtual machine or container) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (for example, radio, air interface) communication with other devices such as UE 304. The one or more transceivers 312 may include one or more radio frequency (RF) components, such as an RF transceiver, a front-end module (for example, an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3. The term “antenna module” may refer to circuitry including one or more antennas as well as one or more other components (such as filters, amplifiers, or processors) associated with integrating the antenna module into a wireless communications device such as the network entity 300 or 302 or the UE 304.

UE 304 may be an example of UE 120. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (for example, via modulation) and/or converts the waveform of a received signal into information (for example, via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (for example, for transmissions) or a data sink (for example, for receptions).

The one or more transceivers 324 may perform processing related to implementing physical layer (for example, radio, air interface) communication with other devices such as other UEs 304 or second network entity 302. The one or more transceivers 324 may include one or more RF components, such as an RF transceiver, a front-end module (for example, an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (for example, a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (for example, a transmit processor) may process (for example, encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (for example, a TX MIMO processor) may perform spatial processing (for example, precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (for example, convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (for example, filter, amplify, downconvert, and digitize) the received signals to obtain input samples. The one or more transceivers 324 and/or the processing system 316 may further process the input samples to obtain received symbols.

The processing system 316 (for example, modem 326, an RX MIMO detector) may obtain the received symbols, perform MIMO detection on the received symbols if applicable, and provide detected symbols. The processing system 316 (for example, a modem 326, a receive processor) may process (for example, de-interleave and decode) the detected symbols. The processing system 316 may provide decoded data for the UE 304 (for example, to an AP 328) and/or decoded control information (for example, to a controller/processor of the processing system 316).

For an example uplink transmission or a sidelink transmission from UE 304, the processing system 316 (for example, modem 326, a transmit processor) may receive and process data and/or control information to obtain a set of symbols for transmission. The data may be for the physical uplink shared channel (PU SC H), and may be received from a data source such as the AP 328. The control information may be for the physical uplink control channel (PU CC H), and may be received, for example, from a controller/processor of the processing system 316. The processing system 316 (for example, a modem 326, the transmit processor) may also generate reference symbols for a reference signal (for example, for a sounding reference signal (SRS), a demodulation reference signal, a phase tracking reference signal, or the like). In some examples, the symbols and/or reference signals may be precoded by the processing system 316 (for example, modem 326, a TX MIMO processor), further processed by the one or more transceivers 324 (for example, for single carrier frequency division multiplexing (SC-FDM)), and transmitted to second network entity 302.

At second network entity 302, the uplink signals from UE 304 may be received by the one or more antennas 314, conditioned by the one or more transceivers 312 (for example, filtered, amplified, downconverted, and digitized), detected (for example, by the processing system 306b such as a modem and/or an RX MIMO detector), and further processed by the processing system 306b (for example, a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communications device, such as first network entity 300, second network entity 302, network entity 110, UE 120, or UE 304, may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). Some aspects and techniques as described herein may be implemented, at least in part, using an AI program (for example, referred to herein as an “AI/ML model”), such as a program that includes a machine learning (ML) model and/or an artificial neural network (ANN) model. The AI/ML model may be deployed at a device (for example, a network entity 300 or 302, a UE 304, an AI/ML server). For example, the AI/ML model may be deployed at a UE 304 (for example, the processing system 316), a network entity 110 (for example, the processing system 306), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 304 and a second portion of the AI/ML model may be deployed at a network entity 300 or 302). In other examples, a first AI/ML model may be deployed at a UE 304 and a second AI/ML model may be deployed at a network entity 300 or 302. The AI/ML model(s) may be configured to enhance various aspects of wireless communication. For example, the AI/ML model(s) may be trained to identify patterns or relationships in data corresponding to the wireless communication, a device, and/or an air interface, among other examples. The AI/ML model(s) may support operational decisions relating to one or more aspects associated with wireless communications devices, networks, or services.

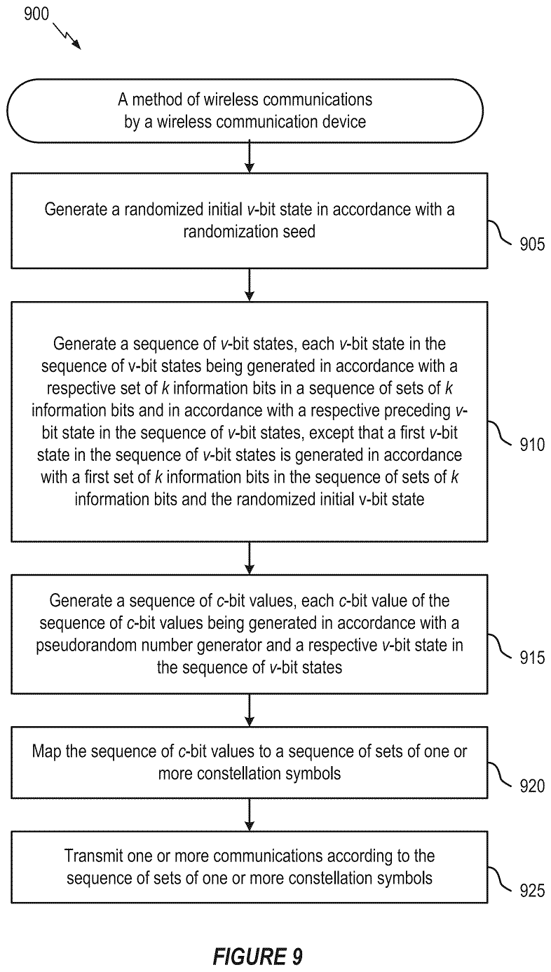

The network entity 110, the UE 120, the CU 210, the DU 230, the RU 240, the network entity 300 or 302, the processing system 306, the UE 304, the processing system 316, or any other component(s) of FIGS. 1, 2, and/or 3 may implement one or more techniques or perform one or more operations associated with spinal coding using a randomized initial state, as described in more detail elsewhere herein. For example, the network entity 110, network entity 300, or network entity 302 (collectively, “network entity 110/300/302”), the UE 120 or UE 304 (collectively, “UE 120/304”), the CU 210, the DU 230, the RU 240, the processing system 306, or the processing system 316 may perform or direct operations of, for example, method 900 of FIG. 9 or other processes as described herein (alone or in conjunction with one or more other processors). Memory of the network entity 110/300/302 may store data and program code (or instructions) for the network entity 110/300/302, the CU 210, the DU 230, or the RU 240. In some examples, the memory of the network entity 110/300/302 may store data relating to a UE 120/304, such as RRC state information or a UE context. Memory of the UE 120/304 may store data and program code (or instructions) for the UE 120/304, such as context information. In some examples, the memory of the UE 120/304 or the memory of the network entity 110/300/302 may include a non-transitory computer-readable medium storing a set of instructions for wireless communication. For example, the set of instructions, when executed by one or more processors (for example, the one or more processors 308 or the one or more processors 318) of the network entity 110/300/302, the UE 120/304, the CU 210, the DU 230, or the RU 240, may cause the one or more processors to perform method 900 of FIG. 9 or other processes as described herein. In some examples, executing instructions may include running the instructions, converting the instructions, compiling the instructions, and/or interpreting the instructions, among other examples.

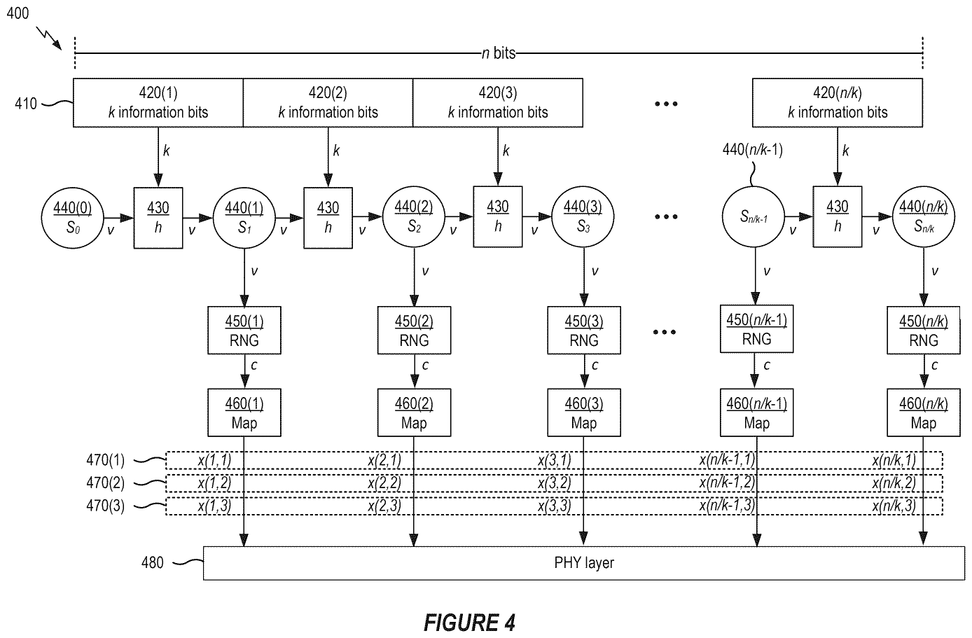

FIG. 4 is a diagram illustrating an example 400 associated with encoding of spinal codes in accordance with the present disclosure. Other transmission schemes may involve different encoding of spinal codes.

As shown, a transmitting device may break up an input message 410 of data into segments (or groups, chunks, or the like) of information bits 420(1)-420(n/k). The input message 410 may have a total of n bits, and each of the segments of information bits 420(1)-420(n/k) may have a total of k bits. Thus, the total quantity of the segments of information bits 420(1)-420(n/k) may be n/k. The transmitting device may sequentially apply, to the segments of information bits 420(1)-420(n/k), a hash function 430 (denoted h). The hash function 430 may be designed such that a difference between two inputs in at least one bit results in a different coded sequence after the at least one bit, which may provide resilience to noise and bit errors.

The hash function 430 may also operate on v-bit states 440(0)-440(n/k−1), where v may be any suitable number (for example, 32). Thus, the hash function 430 may take two inputs: the blocks of information bits 420(1)-420(n/k) and the v-bit states 440(0)-440(n/k−1). The hash function 430 may output the v-bit states 440(1)-440(n/k) based at least in part on the blocks of information bits 420(1)-420(n/k) and the v-bit states 440(0)-440(n/k−1). In some examples, h: {0,1}^{v}×{0,1}^{k}→{0,1}^{v}. In some examples, a v-bit state can be represented as a state Sᵢ=h(sᵢ₋₁, m̅ᵢ), where Sᵢ is an i^{th} v-bit state 440(i) and m̅ᵢ is an i^{th} block of information bits 420(i).

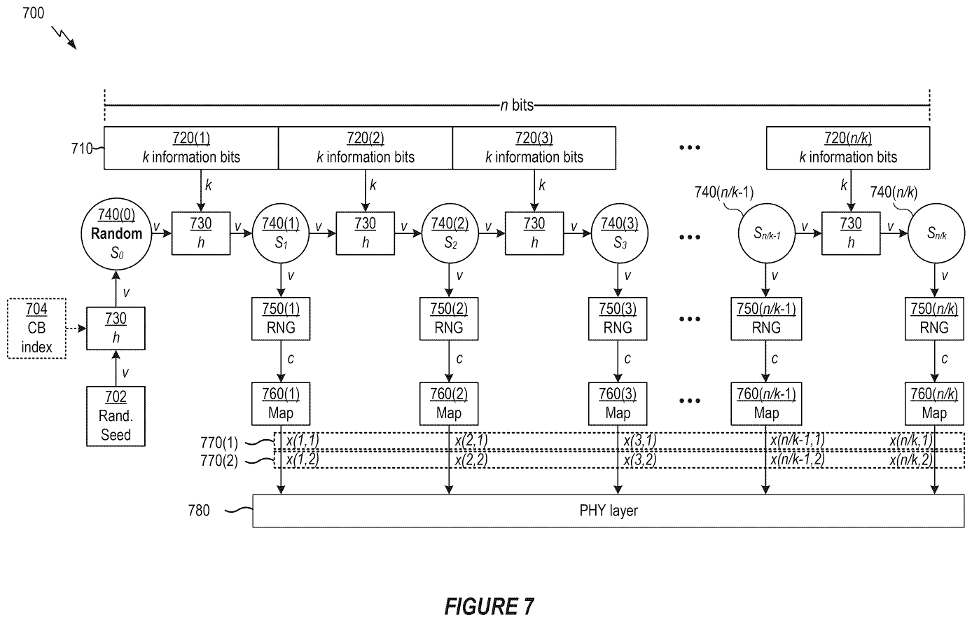

For example, initially, the hash function 430 may take, as input, the block of information bits 420(1) and the v-bit state 440(0) (for example, an initial v-bit state). The hash function 430 and the v-bit state 440(0) may be known to a transmitting device and a receiving device. In some examples, the v-bit state 440(0) may be zero. This can be contrasted with the v-bit state 740(0) of FIG. 7, which may be random. The hash function 430 may first output the v-bit state 440(1), then take, as input, the block of information bits 420(2) and the v-bit state 440(1), and then output the v-bit state 440(2). This process may continue until the hash function 430 outputs the v-bit state 440(n/k). In this manner, the transmitting device may generate a “spine” of v bit states 440(1)-440(n/k) by sequentially hashing together the blocks of information bits 420(1)-420(n/k) from the input message 410 without adding redundancy bits.

The hash function 430 may provide the v-bit states 440(1)-440(n/k) as input (for example, seeds) to random number generators (RNGs) 450(1)-450(n/k). In some examples, the RNGs 450(1)-450(n/k) may be known to the transmitting device and the receiving device. In some aspects, an RNG 450 may be a pseudorandom number generator. The RNGs 450(1)-450(n/k) may generate a sequence of c-bit values (for example, random C-bit binary numbers): RNG: {0,1}^{v}×N→{0,1}^{c}. Thus, the transmitting device may randomly map the blocks of information bits 420(1)-420(n/k) to respective c-bit values. In some examples, a c-bit value may be a binary word that includes c bits. In some examples, the transmitting device may map the sequence of c-bit values to a sequence of IQ constellation symbols using a mapping function 460. For example, the transmitting device may use the mapping function 460 to randomly select the IQ constellation symbols. In this manner, the transmitting device may produce a sequence of coded bits and constellation symbols for transmission. In some examples, the total quantity of the blocks of information bits 420(1)-420(n/k) may be equal to the total quantity of transmitted constellation symbols. While some aspects described herein are described with regard to a quadrature amplitude modulation (QAM) constellation, aspects described herein can be implemented for any form of constellation (for example, a non-square constellation, a Gaussian distributed constellation, or the like).

In some examples, each of the RNGs 450(1)-450(n/k) may generate multiple c-bit values. For example, in a first pass 470(1), the RNGs 450(1)-450(n/k) may generate a first sequence of c-bit values. The transmitting device may, using the mapping function 460, convert the first sequence of c-bit values into a first sequence of IQ constellation symbols. The transmitting device may transmit, at a PHY layer 480, one or more samples corresponding to the first sequence of IQ constellation symbols, and if the receiving device responds with a NACK, then the RNGs 450(1)-450(n/k) may, in a second pass 470(2), generate a second sequence of c-bit values. A sample may occupy a time window (for example, a slot) during which a transmitted signal has a given amplitude and/or phase corresponding to a given symbol (for example, a sample may encode a symbol). The transmitting device may, using the mapping function 460, convert the second sequence of c-bit values into a second sequence of IQ constellation symbols. The transmitting device may transmit, at the PHY layer 480, one or more samples corresponding to the second sequence of IQ constellation symbols, and if the receiving device responds with a NACK, then the RNGs 450(1)-450(n/k) may, in a third pass 470(3), generate a third sequence of c-bit values. The transmitting device may, using the mapping function 460, convert the third sequence of c-bit values into a third sequence of IQ constellation symbols. The transmitting device may transmit, at the PHY layer 480, one or more samples corresponding to the third sequence of IQ constellation symbols.

It should be noted that, in some aspects described herein, only a subset of spinal symbols (and thus c-bit values) are transmitted in a given transmission. Furthermore, the IQ constellation symbols (or other actually transmitted symbols) may be referred to herein as spinal symbols, and may be referred to as being derived from spinal values or spines. This process may continue until the transmitting device receives an ACK from the receiving device or a timeout occurs. As used in FIG. 4, the notation “x(Y,Z)” refers to a Z^{th} pass performed by a Y^{th} RNG 450. In some examples, the transmitting device may transmit one symbol per v-bit state per pass; thus, if the receiving device takes l passes to decode the input message 410, then the effective rate is k/l bits per channel use, where k is the maximum rate.

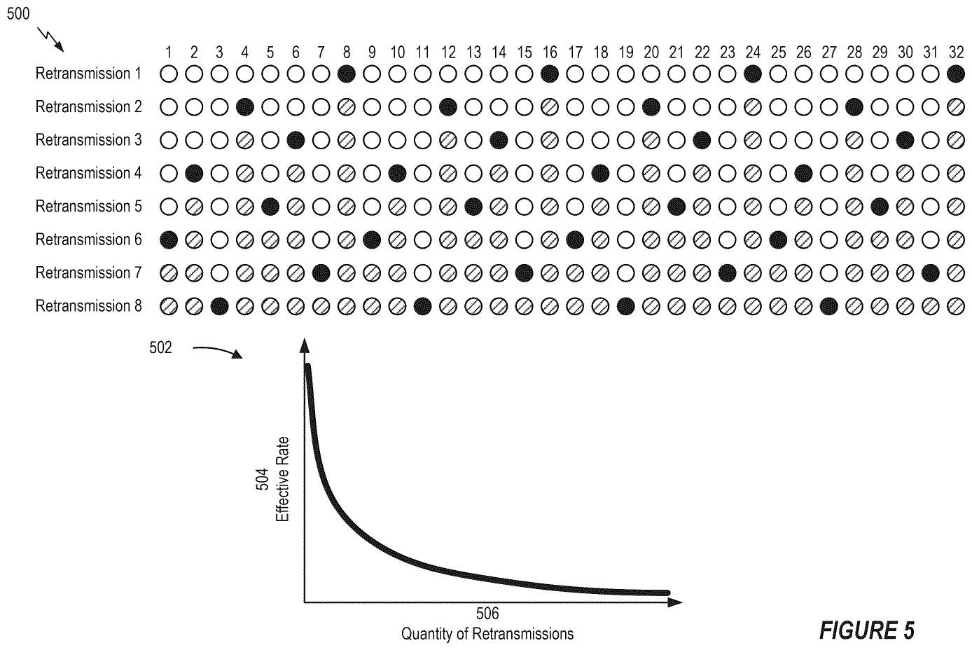

The receiving device (for example, decoder) may sequentially process the received samples until the input message 410 is successfully decoded or a timeout occurs. If the timeout occurs, then the transmitting device may proceed to a subsequent input message. This may be more readily understood with reference to FIG. 5.

FIG. 5 is a diagram illustrating an example 500 associated with a puncturing scheme for spinal codes in accordance with the present disclosure.

In the example 500, a transmitting device may transmit spinal symbols to a receiving device using a quantity of retransmissions (sometimes referred to as a quantity of subpasses), indexed in FIG. 5 as retransmission 1 through retransmission 8 (but which may include more or fewer retransmissions in other examples). In each retransmission, the transmitting device transmits symbols for spine values marked by solid black circles, while cross-hatched circles indicate symbols that have already been transmitted (for example, in a previous retransmission). A quantity of transmitted symbols per retransmission may dictate a rate granularity for the spinal code.

More particularly, in an example in which 256 information bits are to be transmitted (for example, n=256), with each segment of information bits (corresponding to each circle in FIG. 5) including eight bits (for example, k=8), the spinal code may be associated with 32 spines (for example, quantity of spines=N/k=256/8=32, as described above in connection with FIG. 4). In such an example, a quantity (for example, less than all) of the spinal codes may be transmitted in each retransmission. More particularly, in the first retransmission, the spinal symbols associated with spines indexed 8, 16, 24, and 32 may be transmitted, shown using solid black circles in connection with the row corresponding to retransmission 1. In the second retransmission, the spinal symbols associated with spines indexed 4, 12, 20, and 28 may be transmitted, shown using solid black circles in connection with the row corresponding to retransmission 2. Moreover, because the spinal symbols associated with spines indexed 8, 16, 24, and 32 may have previously been transmitted at this point in time (for example, in retransmission 1), those spinal symbols are shown using cross-hatched circles in retransmission 2. The transmitting device may continue to transmit spinal symbols in this manner until the message is successfully decoded by the receiving device or until all spinal symbols have been transmitted (for example, as shown in connection with retransmission 8).

In this regard, the receiving device may attempt to decode the message after each retransmission. In some examples, a receiving device may decode the received spinal symbols using a decoder and/or a decoding algorithm. After at least the initial transmission, the receiving device may successfully decode the message.

Once the message is successfully decoded, the receiving device may transmit an acknowledgement message to the transmitting device, and the transmitting device may forgo transmitting any remaining retransmissions. In that regard, in some examples the spinal code may be considered “rateless,” because a coding rate of the spinal code may not be set and/or may vary based on channel conditions, among other examples. For example, as shown in the plot 502, which includes an effective coding rate axis 504 and a quantity of retransmissions axis 506, an effective coding rate may decrease as a quantity of retransmissions used to transmit a message increases. For example, returning to the example described above, the spinal code may start a rate of 8 bits per channel use and may decrease in a manner consistent with the plot 502 as more retransmissions are used, with the total quantity of transmitted symbols per retransmission (for example, four in the above-described example 500) dictating the effective rate granularity. In some examples, using a spinal code as a rateless code may enable use of the spinal code even in the absence of utilizing CSI-RSs or similar mechanisms for determining optimal transmission schemes (for example, optimal modulation and coding schemes (MCSs), among other examples). In some other examples, a spinal code may be associated with a fixed rate (for example, the rate of the spinal code may be determined and/or fixed when encoding data), in a similar manner to low-density parity check (LDPC) codes and/or polar codes, among other examples. For example, a spinal code encoder may limit a quantity of spinal symbols generated and/or a transmitting device may transmit a fixed quantity of spinal symbols in a channel, thereby setting a fixed rate for the spinal code. Additionally, or alternatively, spinal codes may be used in a similar manner as LDPC codes and/or polar codes, however, an MCS may be used to generate an equivalent puncturing scheme for the spinal code, among other examples.

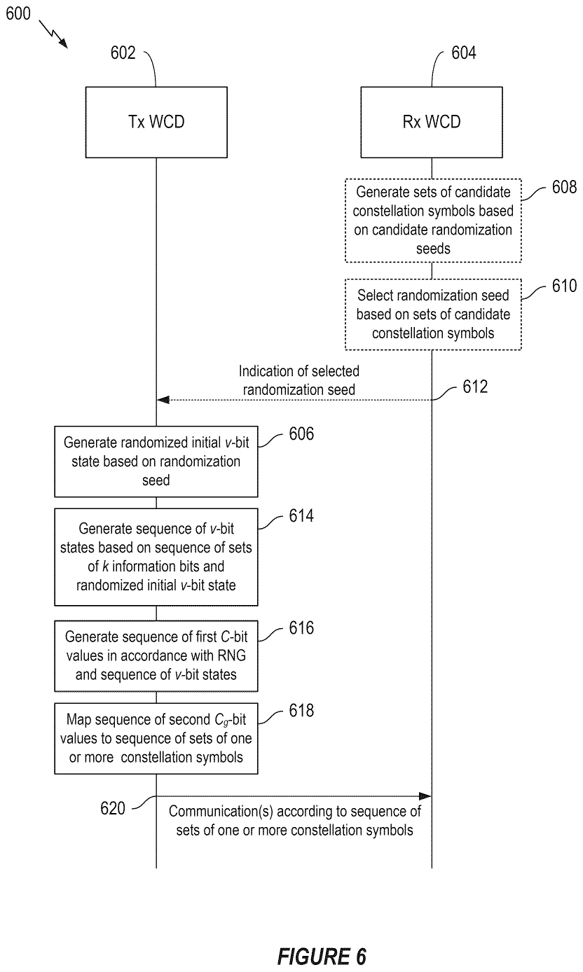

FIG. 6 is a diagram illustrating an example 600 of signaling associated with spinal coding using a randomized initial state. The example 600 includes a transmitting wireless communications device 602 (such as UE 120, UE 304, network entity 110, first network entity 300, or second network entity 302) and a receiving wireless communications device 604 (such as UE 120, UE 304, network entity 110, first network entity 300, or second network entity 302). The description of FIG. 6 also refers to elements of FIG. 7 to improve clarity. FIG. 7 is a diagram illustrating an example of spinal coding using a randomized initial state.

As shown at 606, the transmitting wireless communication device 602 may generate a randomized initial v-bit state in accordance with a randomization seed (for example, an initial value used to seed a hash function h). For example, with reference to FIG. 7, the transmitting wireless communications device 602 may apply a hash function 730 (denoted h) to a v-bit randomization seed 702. As shown in FIG. 7, an output of the hash function 730 may be a randomized initial v-bit state 740(0). In some aspects, the wireless communications device 602 may generate the randomization seed without use of a hash function h. For example, the wireless communications device 602 may in some aspects use a seed for a DMRS as the randomized initial v-bit state (e.g., generating the randomized initial v-bit state may include obtaining or otherwise determining the seed for the DMRS).

In some aspects, the randomization seed may include a randomization identifier configured for the transmitting wireless communication device 602. The randomization identifier may be, for example, a value configured specifically for use in generating the randomized initial v-bit state with respect to the spinal coding procedure. In some aspects, the transmitting wireless communication device 602 may receive, from the receiving wireless communications device 604, a configuration indicating the randomization identifier.

Additionally or alternatively, the randomization seed may include another value that is configured on the transmitting wireless communication device 602 (for example, a value configured for use for another purpose). As one example, the randomization seed may include scrambling identifier configured for the transmitting wireless communication device 602 (for example, a value configured for initializing a DMRS scrambling sequence). As another example, the randomization seed may include a RNTI configured for the transmitting wireless communication device 602 (for example, a value configured for scrambling cyclic redundancy check (CRC) bits attached to a downlink control information (DCI) payload). As another example, the randomization seed may include a cell identifier configured for the transmitting wireless communication device 602 wireless communications device (for example, a physical cell identifier of a cell to which the transmitting wireless communication device 602 is connected).

Additionally or alternatively, the randomization seed may be (dynamically) indicated to the transmitting wireless communication device 602 by the receiving wireless communications device 604. For example, as shown at 608, the receiving wireless communications device 604 may generate a plurality of sets of candidate constellation symbols based at least in part on a plurality of candidate randomization seeds, with each set of candidate constellation symbols corresponding to a different one of the candidate randomization seeds. That is, the receiving wireless communications device 604 may store or have access to a plurality of candidate randomization seeds. The plurality of candidate randomization seeds may be similarly configured (for example, semi-statically configured) on the transmitting wireless communication device 602. In some aspects, the receiving wireless communications device 604 may generate a set of one or more constellation symbols for each candidate randomization seed. Next, as shown at the receiving wireless communications device 604 may select a randomization seed, from the plurality of candidate randomization seeds, based at least in part on the plurality of sets of candidate constellation symbols. For example, the receiving wireless communications device 604 may evaluate a performance of each randomization seed based on the associated set of constellation symbols, and may select the candidate randomization seed that provides the best performance (for a current modulation and coding scheme (MCS) and slot). In one example, the receiving wireless communications device 604 may evaluate the performance of the candidate randomization seeds based on distances between constellation points associated with the sets of constellation symbols. In this example, the receiving wireless communications device 604 may select the candidate randomization seed that provides the set of constellation symbols having a greatest distance between constellation points. As shown at 612, the receiving wireless communications device 604 may transmit an indication of the selected randomization seed to the transmitting wireless communication device 602. The transmitting wireless communication device 602 may receive the indication of the selected randomization seed, and may identify the randomization seed (for example, from among the plurality of candidate randomization seeds configured on the transmitting wireless communication device 602), in accordance with the indication. In this way, the randomization seed may be selected using a dynamic selection process so as to allow the receiving wireless communications device 604 to optimize performance based on varying conditions (for example, because the best-performing seed may differ for different MCSs and among different slots due to the dependency on a slot index).

In some aspects, the transmitting wireless communication device 602 may generate the randomized initial v-bit state further based on a code block index value associated with the sequence of sets of k information bits. The code block index value may include, for example, an index value associated with a code block that comprises the sets of k information bits. For example, with reference to FIG. 7, the transmitting wireless communications device 602 may provide a code block (CB) index value 704 as an input to the hash function 730 (in addition to providing the v-bit randomization seed 702 as an input to the hash function 730) in association with generating the randomized initial v-bit state 740(0). In some aspects, the use of the code block index value 704 in association with generating the randomized initial v-bit state 740(0) may serve to further increase randomness of the randomized initial v-bit state 740(0). In some aspects, such a technique may be used to increase randomness among different code blocks.

As shown at 614, the transmitting wireless communications device 602 may generate a sequence of v-bit states. In some aspects, each v-bit state in the sequence of v-bit states is generated in accordance with a respective set of k information bits in a sequence of sets of k information bits and in accordance with a respective preceding v-bit state in the sequence of v-bit states. In some aspects, each v-bit state is generated based on a hash function h.

In some aspects, a first v-bit state in the sequence of v-bit states is generated based on the randomized initial v-bit state. Thus, in some aspects, the first v-bit state of the sequence of v-bit states is generated (e.g., in accordance with the hash function h) based at least in part on the randomized initial v-bit state and a first set of k information bits of the sequence of sets of k information bits, and the second v-bit state of the sequence of v-bit states is generated (e.g., in accordance with the hash function h) based at least in part on the first v-bit state and a second set of k information bits of the sequence of sets of k information bits. In general, the hash function h, if used, may be any function that receives two inputs (for example, an input v-bit state and a set of k information bits) and provides a random result (for example, an output v-bit state).

For example, with reference to FIG. 7, the transmitting wireless communications device 602 may break up an input message 710 of data into segments (or groups, chunks, or the like) of information bits 720(1)-720(n/k). The message may have a total of n bits, and each of the segments of information bits 720(1)-720(n/k) may have a total of k bits. Thus, the total quantity of the segments of information bits 720(1)-720(n/k) may be n/k. The transmitting wireless communications device 602 may sequentially apply a hash function 730 (denoted h) to the segments of information bits 720(1)-720(n/k). The hash function 730 may be designed such that a difference between two input messages in at least one bit results in a different coded sequence after the at least one bit, which may provide resilience to noise and bit errors. The hash function 730 may also operate on v-bit states 740(0)-740(n/k−1), where v may be any suitable number (for example, 32). Thus, the hash function 730 may take two inputs: the blocks of information bits 720(1)-720(n/k) and the v-bit states 740(0)-740(n/k−1). The hash function 730 may output the v-bit states 740(1)-740(n/k) based at least in part on the blocks of information bits 720(1)-720(n/k) and the v-bit states 740(0)-740(n/k−1). In some examples, h: {0,1}^{v}×→{0,1}^{v}. In some examples, a v-bit state can be represented as a state Sᵢ=h(sᵢ₋₁, m̅ᵢ), where Sᵢ is an i^{th} v-bit state 740(i) and m̅ᵢ is an i^{th} block of information bits 720(i).

For example, initially, the hash function 730 may take, as input, the block of information bits 720(1) and the randomized initial v-bit state 740(0). The hash function 730 and the randomized initial v-bit state 740(0) may be known to the transmitting wireless communication device 602 and the receiving wireless communications device 604. The hash function 730 may output the v-bit state 740(1), take, as input, the block of information bits 720(2) and the v-bit state 740(1), and output the v-bit state 740(2). This process may continue until the hash function 730 outputs the v-bit state 740(n/k). In this manner, the transmitting wireless communication device 602 may generate a “spine” of v bit states 740(1)-740(n/k) by sequentially hashing together the blocks of information bits 720(1)-720(n/k) from the input message 710 without adding redundancy bits.

As shown at 616, the transmitting wireless communications device 602 may generate a sequence of first c-bit values, where each first c-bit value of the sequence of first c-bit values is generated in accordance with a pseudorandom number generator and a respective v-bit state in the sequence of v-bit states. For example, a first c-bit value of the sequence of first c-bit values may be generated based at least in part on the first v-bit state, and a second c-bit value of the sequence of first c-bit values may be generated based at least in part on the second v-bit state. In some examples, with reference to the Figured 7, the RNGs 750(1)-750(n/k) may be known to the transmitting wireless communications device 602 and the receiving wireless communications device 604. In some aspects, the c-bit value represents a value C. For example, the value C may be a binary vector, comprising a series of zeros and ones, with a length of c bits.

The RNGs 750(1)-750(n/k) may generate a sequence of first c-bit values (for example, a sequence of binary words that each include c bits): RNG: {0,1}^{v}×N→{0,1}^{c}. Thus, the transmitting wireless communications device 602 may randomly map the blocks of information bits 720(1)-720(n/k) to respective first c-bit values. For example, with reference to FIG. 7, the v-bit state 740(1) output by the hash function 730 may be used a seed to an RNG 750(1), and the RNG 750(1) may generate a first c-bit value (for example, a c-bit binary number). Other v-bit states 740(2)-740(n/k) generated by the hash function 730 can be provided to respective RNGs 750(2)-750(n/k) in similar manner so as to generate a sequence of first c-bit values.

In some aspects, the RNG 750 may map a v-bit state based at least in part on a quantity of retransmissions associated with a given spine. That is, the RNG 750 may in some aspects map the v-bit state to a plurality of c-bit values, where a total quantity of bits in the plurality of c-bit values is equal to the quantity of bits in a single c-bit value (that is, the quantity of bits c) times the quantity of retransmissions associated with the given spine. Of note, the techniques and apparatuses described herein can be applied to a sequence of c-bit values, wherein the sequence of c-bit values includes a plurality of c-bit values generated from a single v-bit state. In this way, any number of retransmissions associated with any one or more spines and/or implementation of a puncturing configuration can be supported.

As shown at 618, the transmitting wireless communications device 602 may map the sequence of c-bit values to a sequence of sets of one or more constellation symbols. That is the transmitting wireless communications device 602 may map each c-bit value in the sequence of c-bit values to a respective set of (IQ) constellation symbols in a sequence of one or more constellation symbols. For example, the first c-bit value may be mapped to a first set of one or more constellation symbols of the sequence of sets of one or more constellation symbols, and the second c-bit value may be mapped to a second set of one or more constellation symbols of the sequence of sets of one or more constellation symbols. In some aspects, with reference to FIG. 7, the transmitting wireless communications device 602 may map a c-bit value to a set of one or more constellation symbols using a mapping function 760. For example, the transmitting wireless communications device 602 may use the mapping function 760 to select the set of one or more constellation symbols based on the c-bit value. In this manner, the transmitting wireless communications device 602 may produce a sequence of coded bits and constellation symbols for transmission. In some examples, the total quantity of the blocks of information bits 720(1)-720(n/k) may be equal to the total quantity of transmitted symbols.

As shown at 620, the transmitting wireless communications device 602 may transmit one or more communications according to the sequence of sets of one or more constellation symbol. For example, with reference to FIG. 7, the transmitting wireless communications device 602 may transmit, at a PHY layer 780, one or more samples corresponding to one or more sets of one or more constellation symbols in a manner similar to that depicted and described above with respect to FIG. 4. As used in FIG. 7, the notation “x(Y,Z)” refers to a Z^{th} pass performed by a Y^{th} RNG 750. In some examples, the transmitting wireless communications device 602 may transmit one symbol per v-bit state per pass; thus, if the receiving device takes l passes to decode the input message 710, then the effective rate is

$$\frac{k}{l}$$

bits per channel use, where k is the maximum rate.

In some aspects, in association with transmitting the one or more communications, the transmitting wireless communications device 602 may perform a normalization operation associated with a set of one or more constellation symbols, and may modulate a communication according to the set of one or more constellation symbols based at least in part on a result of performing the normalization operation. In practice, an average power of an entire transmitted symbol should be normalized (for example, to 1). Therefore, the transmitting wireless communications device 602 may in some aspects perform the normalization so as to adjust a modulation table (for example, a QAM table) to cause the average power of an entire transmitted symbol to be normalized to 1.

In some aspects, the techniques and apparatuses described with respect to FIGS. 6 and 7 enable spinal coding to be implemented using a randomized initial v-bit state. The randomized initial v-bit state serves to allow a BLER achieved by the spinal coding procedure to move closer to the Shannon limit and to increase consistency of the BLER achieved by the spinal coding procedure (for example, as compared to setting the initial v-bit state to zero).

Of further note, the RNG 750 described herein is configured to output a c-bit value that comprises a sequence of bits (for example, 0111) that represent a symbol. However, in some aspects, the RNG 750 may be configured to output an integer index C that represents the symbol (for example, 7), rather than a sequence of bits that represents the symbol.

In some aspects, the techniques and apparatuses depicted and described with respect to FIGS. 6 and 7 may be applied to a spinal coding procedure that uses code block segmentation for segmenting a code block into multiple (shorter) sub-code-blocks (for example, to simplify encoder and decoder implementation and reduce complexity of a MIMO spinal code decoder).

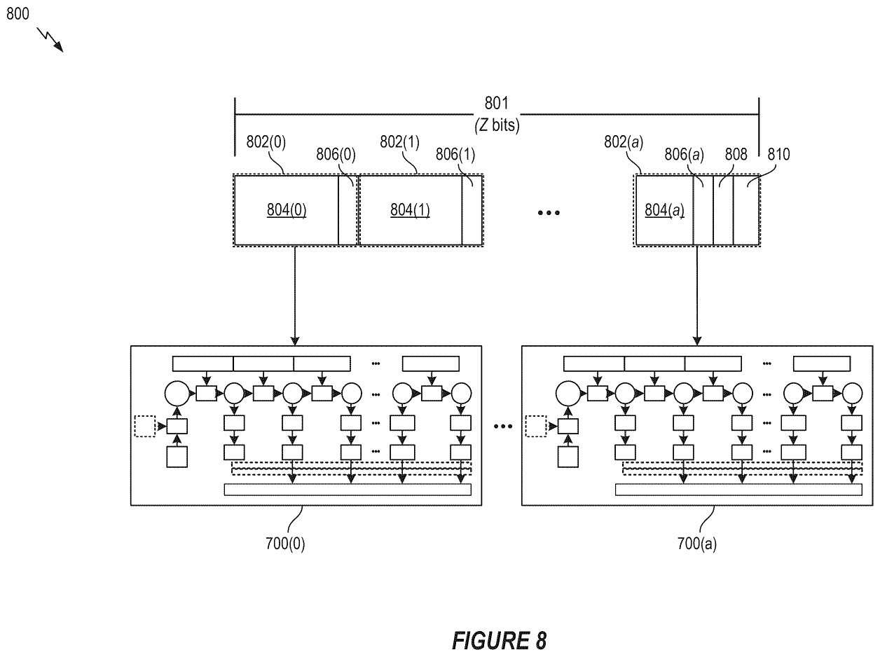

FIG. 8 is a diagram illustrating an example 800 of spinal coding using a randomized initial state and code block segmentation for segmenting a code block into multiple sub-code-blocks.

In the example 800, a code block 801 comprises a total of Z bits. As shown, the code block 801 comprises a plurality of sub-code-blocks 802(0) through 802(a) (a>1). As shown, each sub-code-block 802 may comprise a respective set of information bits 804 and a respective set of tail bits 806 (for example, a copy of a first L bits of the respective set of information bits). As further shown, the code block 801 may further comprise an R-bit CRC 808 and a 24-bit CRC 810, which may be generated and concatenated to the code block 801 prior to segmentation into the plurality of sub-code-blocks 802.

As shown in the example 800, after segmentation into the plurality of sub-code-blocks 802, each of the plurality of sub-code-blocks 802 may be provided to a respective spinal code encoder 700 (for example, an encoder illustrated in the example 700 of FIG. 7) for encoding. Thus, the spinal encoding of each sub-code-block 802 may be performed using a respective randomized initial v-bit state. In some aspects, spinal encoding of two or more sub-code-blocks 802 of the plurality of sub-code-blocks 802 in this manner may be performed at least partially in parallel, thereby reducing latency attributable to the spinal coding process.

In some aspects, the techniques and apparatuses depicted and described with respect to the use of a randomized initial v-bit state enhance performance of a spinal coding procedure that uses code block segmentation such as that shown in the example 800. For example, the techniques and apparatuses depicted and described with respect to the use of a randomized initial v-bit state serve to increase randomness that would be otherwise degraded due to the segmentation of the code block 801 into (shorter) sub-code-blocks 802.

### Example Operations of a Wireless Communications Device

FIG. 9 shows a method 900 for wireless communication by a wireless communications device, such as UE 120 of FIG. 1, UE 304 of FIG. 3, a network entity 110 of FIG. 1, a first network entity 300 or a second network entity 302 of FIG. 3, a disaggregated basestation as discussed with respect to FIG. 2, or a transmitting wireless communications device 602 of FIG. 6.

Method 900 begins at block 905 with generating a randomized initial v-bit state in accordance with a randomization seed. For example, the transmitting wireless communication device 602 may generate a randomized initial v-bit state in accordance with a randomization seed, as depicted and described with respect to operation 606 of FIG. 6. In some aspects, the initial v-bit state may not be truly random. For example, the initial v-bit state may be pseudorandom.

Method 900 then proceeds to block 910 with generating a sequence of v-bit states, each v-bit state in the sequence of v-bit states being generated in accordance with a respective set of k information bits in a sequence of sets of k information bits and in accordance with a respective preceding v-bit state in the sequence of v-bit states, except that a first v-bit state in the sequence of v-bit states is generated in accordance with a first set of k information bits in the sequence of sets of k information bits and the randomized initial v-bit state. For example, the transmitting wireless communication device 602 may generate a sequence of v-bit states, each v-bit state in the sequence of v-bit states being generated in accordance with a respective set of k information bits in a sequence of sets of k information bits and in accordance with a respective preceding v-bit state in the sequence of v-bit states, except that a first v-bit state in the sequence of v-bit states is generated in accordance with a first set of k information bits in the sequence of sets of k information bits and the randomized initial v-bit state, as depicted and described with respect to operation 614 of FIG. 6.

Method 900 then proceeds to block 915 with generating a sequence of c-bit values, each c-bit value of the sequence of c-bit values being generated in accordance with a pseudorandom number generator and a respective v-bit state in the sequence of v-bit states. For example, the transmitting wireless communication device 602 may generate a sequence of c-bit values, as depicted and described with respect to operation 616 of FIG. 6.

Method 900 then proceeds to block 920 with mapping the sequence of c-bit values to a sequence of sets of one or more constellation symbols. For example, the transmitting wireless communication device 602 may map the sequence of c-bit values to a sequence of sets of one or more constellation symbols, as depicted and described with respect to operation 618 of FIG. 6.

Method 900 then proceeds to block 925 with transmitting one or more communications according to the sequence of sets of one or more constellation symbols. For example, the transmitting wireless communication device 602 may transmit one or more communications according to the sequence of one or more constellation symbols, as depicted and described with respect to operation 620 of FIG. 6.

In some aspects, the randomization seed is a randomization identifier configured for the wireless communications device, wherein the randomization identifier is a value configured specifically for use in generating the randomized initial v-bit state.

In some aspects, method 900 further includes receiving a configuration indicating the randomization identifier.

In some aspects, the randomization seed comprises a scrambling identifier configured for the wireless communications device.

In some aspects, the randomization seed comprises a RNTI configured for the wireless communications device.

In some aspects, the randomization seed comprises a cell identifier configured for the wireless communications device.

In some aspects, method 900 further includes receiving an indication of a network-selected randomization seed.

In some aspects, method 900 further includes identifying the randomization seed as the network-selected randomization seed.

In some aspects, block 905 includes generating the randomized initial v-bit state further based on a code block index value associated with the sequence of sets of k information bits.

In some aspects, the techniques and apparatuses described with respect to the method 900 enable spinal coding to be implemented using a randomized initial v-bit state, which serves to allow a BLER achieved by the spinal coding procedure to move closer to the Shannon limit and to increase consistency of the BLER achieved by the spinal coding procedure.

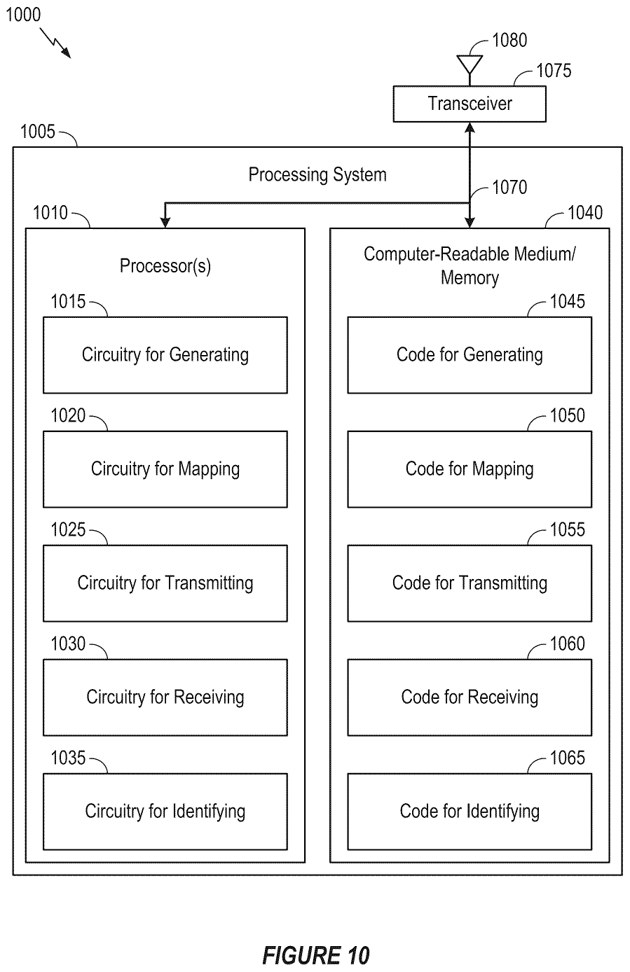

In some aspects, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000 configured for wireless communications. In some aspects, the communications device 1000 is a UE, such as a UE 120 of FIG. 1 or a UE 304 of FIG. 3. In some aspects, communications device 1000 is a network entity, such as network entity 110 of FIG. 1, a first network entity 300 or second network entity 302 of FIG. 3, or a disaggregated base station as discussed with respect to FIG. 2. In some aspects, the communications device 1000 is a transmitting wireless communications device 602 of FIG. 6.

The communications device 1000 includes a processing system 1005 coupled to a transceiver 1075 (e.g., a transmitter and/or a receiver). The transceiver 1075 is configured to transmit and receive signals for the communications device 1000 via an antenna 1080, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1040. In various aspects, the one or more processors 1010 may be representative of the one or more processors 318 described with respect to FIG. 3. The one or more processors 1010 are coupled to a computer-readable medium/memory 1040 via a bus 1070. In some aspects, the computer-readable medium/memory 1040 may be representative of the one or more memories 320 described with respect to FIG. 3. The computer-readable medium/memory 1040 is a non-transitory computer-readable medium/memory. In certain aspects, the computer-readable medium/memory 1040 is configured to store instructions (e.g., computer-executable code), that when executed by the one or more processors 1010, cause the one or more processors 1010 to perform the method 900 described with respect to FIG. 9, or any aspect related to it, including any operations described in relation to FIG. 9. Note that reference to a processor performing a function of communications device 1000 may include one or more processors performing that function of communications device 1000, such as in a distributed fashion.

In the depicted example, computer-readable medium/memory 1040 stores code (e.g., executable instructions), including code for generating 1045, code for mapping 1050, code for transmitting 1055, code for receiving 1060, and code for identifying 1065. Processing of the code 1045-965 may enable and cause the communications device 1000 to perform the method 900 described with respect to FIG. 9, or any aspect related to it. For instance, in some aspects, code for generating 1045 includes code for generating a randomized initial v-bit state in accordance with a randomization seed. In some aspects, code for generating 1045 includes code for generating a sequence of v-bit states, each v-bit state in the sequence of v-bit states being generated in accordance with a respective set of k information bits in a sequence of sets of k information bits and in accordance with a respective preceding v-bit state in the sequence of v-bit states, except that a first v-bit state in the sequence of v-bit states is generated in accordance with a first set of k information bits in the sequence of sets of k information bits and the randomized initial v-bit state. In some aspects, code for generating 1045 includes code for generating a sequence of c-bit values, each c-bit value of the sequence of c-bit values being generated in accordance with a pseudorandom number generator and a respective v-bit state in the sequence of v-bit states. In some aspects, code for mapping 1050 includes code for mapping the sequence of c-bit values to a sequence of sets of one or more constellation symbols. In some aspects, code for transmitting 1055 includes code for transmitting one or more communications according to the sequence of sets of one or more constellation symbols.

The one or more processors 1010 include circuitry configured to implement (e.g., execute) the code stored in the computer-readable medium/memory 1040, including circuitry for generating 1015, circuitry for mapping 1020, circuitry for transmitting 1025, circuitry for receiving 1030, and circuitry for identifying 1035. Processing with circuitry 1015-1035 may enable and cause the communications device 1000 to perform the method 900 described with respect to FIG. 9, or any aspect related to it. For instance, in some aspects, circuitry for generating 1015 includes circuitry for generating a randomized initial v-bit state in accordance with a randomization seed. In some aspects, circuitry for generating 1015 includes circuitry for generating a sequence of v-bit states, each v-bit state in the sequence of v-bit states being generated in accordance with a respective set of k information bits in a sequence of sets of k information bits and in accordance with a respective preceding v-bit state in the sequence of v-bit states, except that a first v-bit state in the sequence of v-bit states is generated in accordance with a first set of k information bits in the sequence of sets of k information bits and the randomized initial v-bit state. In some aspects, circuitry for generating 1015 includes circuitry for generating a sequence of c-bit values, each c-bit value of the sequence of c-bit values being generated in accordance with a pseudorandom number generator and a respective v-bit state in the sequence of v-bit states. In some aspects, circuitry for mapping 1020 includes circuitry for mapping the sequence of c-bit values to a sequence of sets of one or more constellation symbols. In some aspects, circuitry for transmitting 1025 includes circuitry for transmitting one or more communications according to the sequence of sets of one or more constellation symbols.

More generally, means for communicating, transmitting, sending or outputting for transmission may include the one or more transceivers 324, one or more antenna 322 and/or processing system 316 of the UE 304 illustrated in FIG. 3, transceiver 1075 and/or antenna 1080 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1075 and/or antenna 1080 of the communications device 1000 in FIG. 10, and/or one or more processors 1010 of the communications device 1000 in FIG. 10.

### Example Operations of a Wireless Communications Device

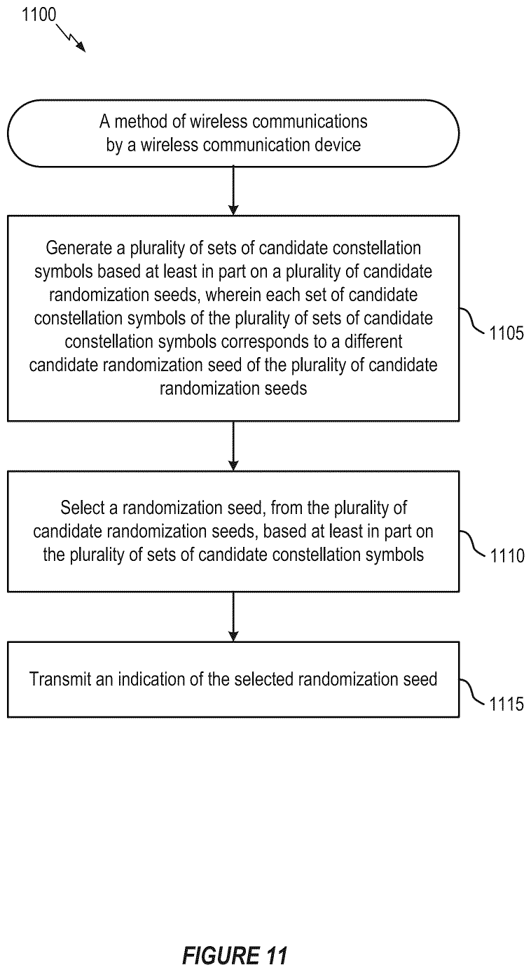

FIG. 11 shows a method 1100 for wireless communication by a wireless communications device, such as UE 120 of FIG. 1, UE 304 of FIG. 3, a network entity 110 of FIG. 1, a first network entity 300 or a second network entity 302 of FIG. 3, a disaggregated base station as discussed with respect to FIG. 2, or a receiving wireless communications device 604 of FIG. 6.

Method 1100 begins at block 1105 with generating a plurality of sets of candidate constellation symbols based at least in part on a plurality of candidate randomization seeds, wherein each set of candidate constellation symbols of the plurality of sets of candidate constellation symbols corresponds to a different candidate randomization seed of the plurality of candidate randomization seeds. For example, the receiving wireless communications device 604 may generate a plurality of sets of candidate constellation symbols based at least in part on a plurality of candidate randomization seeds, as depicted and described with respect to operation 608 of FIG. 6.

Method 1100 then proceeds to block 1110 with selecting a randomization seed, from the plurality of candidate randomization seeds, based at least in part on the plurality of sets of candidate constellation symbols. For example, the receiving wireless communications device 604 may select a randomization seed, from the plurality of randomization seeds, based at least in part on the plurality of sets of candidate constellation symbols, as depicted and described with respect to operation 610 of FIG. 6.

Method 1100 then proceeds to block 1115 with transmitting an indication of the selected randomization seed. For example, the receiving wireless communications device 604 may transmit an indication of the selected randomization seed, as depicted and described with respect to operation 612 of FIG. 6.

In some aspects, method 1100 further includes evaluating a performance of each candidate randomization seed, in the plurality of randomization seeds, based on a respective set of candidate symbols of the plurality of sets of candidate constellation symbols, wherein selecting the randomization seed comprises selecting the randomization seed based at least in part on a result of evaluating the performance of each candidate randomization seed.

In some aspects, method 1100 further includes evaluating the performance of a candidate randomization seed, of the plurality of candidate randomization seeds, based on distances between constellation points associated with a candidate set of constellation symbols associated with the candidate randomization seed.

In some aspects, the performance of each candidate randomization seed is with respect to a current MCS and a current slot.

In some aspects, the techniques and apparatuses described with respect to the method 1100 enable spinal coding to be implemented using a randomized initial v-bit state, which serves to allow a BLER achieved by the spinal coding procedure to move closer to the Shannon limit and to increase consistency of the BLER achieved by the spinal coding procedure.

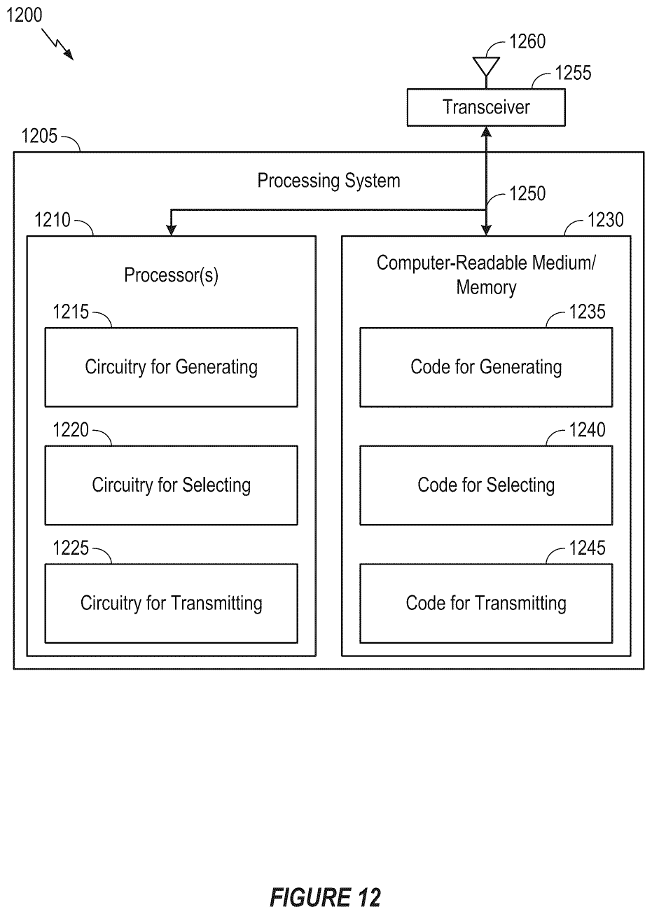

In some aspects, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, the communications device 1200 is a UE, such as a UE 120 of FIG. 1 or a UE 304 of FIG. 3. In some aspects, communications device 1000 is a network entity, such as a network entity 110 of FIG. 1, a first network entity 300 or second network entity 302 of FIG. 3, or a disaggregated base station as discussed with respect to FIG. 2. Is the communications device 1200 is a receiving wireless communications device 604 of FIG. 6.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, the one or more processors 1210 may be representative of the one or more processors 318 described with respect to FIG. 3. The one or more processors 1210 are coupled to a computer-readable medium/memory 1230 via a bus 1250. In some aspects, the computer-readable medium/memory 1230 may be representative of the one or more memories 320 described with respect to FIG. 3. The computer-readable medium/memory 1230 is a non-transitory computer-readable medium/memory. In certain aspects, the computer-readable medium/memory 1230 is configured to store instructions (e.g., computer-executable code), that when executed by the one or more processors 1210, cause the one or more processors 1210 to perform the method 1100 described with respect to FIG. 11, or any aspect related to it, including any operations described in relation to FIG. 11. Note that reference to a processor performing a function of communications device 1200 may include one or more processors performing that function of communications device 1200, such as in a distributed fashion.

In the depicted example, computer-readable medium/memory 1230 stores code (e.g., executable instructions), including code for generating 1235, code for selecting 1240, and code for transmitting 1245. Processing of the code 1235-1145 may enable and cause the communications device 1200 to perform the method 1100 described with respect to FIG. 11, or any aspect related to it. For instance, in some aspects, code for generating 1235 includes code for generating a plurality of sets of candidate constellation symbols based at least in part on a plurality of candidate randomization seeds, wherein each set of candidate constellation symbols of the plurality of sets of candidate constellation symbols corresponds to a different candidate randomization seed of the plurality of candidate randomization seeds. In some aspects, code for selecting 1240 includes code for selecting a randomization seed, from the plurality of candidate randomization seeds, based at least in part on the plurality of sets of candidate constellation symbols. In some aspects, code for transmitting 1245 includes code for transmitting an indication of the selected randomization seed.

The one or more processors 1210 include circuitry configured to implement (e.g., execute) the code stored in the computer-readable medium/memory 1230, including circuitry for generating 1215, circuitry for selecting 1220, and circuitry for transmitting 1225. Processing with circuitry 1215-1225 may enable and cause the communications device 1200 to perform the method 1100 described with respect to FIG. 11, or any aspect related to it. For instance, in some aspects, circuitry for generating 1215 includes circuitry for generating a plurality of sets of candidate constellation symbols based at least in part on a plurality of candidate randomization seeds, wherein each set of candidate constellation symbols of the plurality of sets of candidate constellation symbols corresponds to a different candidate randomization seed of the plurality of candidate randomization seeds. In some aspects, circuitry for selecting 1220 includes circuitry for selecting a randomization seed, from the plurality of candidate randomization seeds, based at least in part on the plurality of sets of candidate constellation symbols. In some aspects, circuitry for transmitting 1225 includes circuitry for transmitting an indication of the selected randomization seed.

More generally, means for communicating, transmitting, sending or outputting for transmission may include the one or more transceivers 324, one or more antenna 322 and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12.

### Example Clauses

Implementation examples are described in the following numbered clauses:

Clause 1: A method of wireless communication by a wireless communications device, comprising: generating a randomized initial v-bit state in accordance with a randomization seed; generating a sequence of v-bit states, each v-bit state in the sequence of v-bit states being generated in accordance with a respective set of k information bits in a sequence of sets of k information bits and in accordance with a respective preceding v-bit state in the sequence of v-bit states, except that a first v-bit state in the sequence of v-bit states is generated in accordance with a first set of k information bits in the sequence of sets of k information bits and the randomized initial v-bit state; generating a sequence of c-bit values, each c-bit value of the sequence of c-bit values being generated in accordance with a pseudorandom number generator and a respective v-bit state in the sequence of v-bit states; mapping the sequence of c-bit values to a sequence of sets of one or more constellation symbols; and transmitting one or more communications according to the sequence of sets of one or more constellation symbols.

Clause 2: The method of Clause 1, wherein the randomization seed is a randomization identifier configured for the wireless communications device, wherein the randomization identifier is a value configured specifically for use in generating the randomized initial v-bit state.

Clause 3: The method of Clause 2, further comprising receiving a configuration indicating the randomization identifier.

Clause 4: The method of any one of Clauses 1-3, wherein the randomization seed comprises a scrambling identifier configured for the wireless communications device.

Clause 5: The method of any one of Clauses 1-4, wherein the randomization seed comprises an RNTI configured for the wireless communications device.

Clause 6: The method of any one of Clauses 1-5, wherein the randomization seed comprises a cell identifier configured for the wireless communications device.

Clause 7: The method of any one of Clauses 1-6, further comprising: receiving an indication of a network-selected randomization seed, and identifying the randomization seed as the network-selected randomization seed.

Clause 8: The method of any one of Clauses 1-7, wherein generating the randomized initial v-bit state comprises generating the randomized initial v-bit state further based on a code block index value associated with the sequence of sets of k information bits.

Clause 9: A method of wireless communication by a wireless communications device, comprising: generating a plurality of sets of candidate constellation symbols based at least in part on a plurality of candidate randomization seeds, wherein each set of candidate constellation symbols of the plurality of sets of candidate constellation symbols corresponds to a different candidate randomization seed of the plurality of candidate randomization seeds; selecting a randomization seed, from the plurality of candidate randomization seeds, based at least in part on the plurality of sets of candidate constellation symbols; and transmitting an indication of the selected randomization seed.

Clause 10: The method of Clause 9, wherein further comprising evaluating a performance of each candidate randomization seed, in the plurality of randomization seeds, based on a respective set of candidate symbols of the plurality of sets of candidate constellation symbols, wherein selecting the randomization seed comprise selecting the randomization seed based at least in part on a result of evaluating the performance of each candidate randomization seed.

Clause 11: The method of Clause 10, wherein evaluating the performance of a candidate randomization seed of the plurality of candidate randomization seeds comprises evaluating the performance of the candidate randomization seed based on distances between constellation points associated with a candidate set of constellation symbols associated with the candidate randomization seed.

Clause 12: The method of any one of Clauses 10-11, wherein the performance of each candidate randomization seed is with respect to a current MCS and a current slot.

Clause 13: One or more apparatuses, comprising: one or more memories comprising executable instructions; and one or more processors configured to execute the executable instructions and cause the one or more apparatuses to perform a method in accordance with any one of Clauses 1-12.

Clause 14: One or more apparatuses configured for wireless communications, comprising: one or more memories; and one or more processors, coupled to the one or more memories, configured to cause the one or more apparatuses to perform a method in accordance with any one of Clauses 1-12.

9 Clause 15: One or more apparatuses configured for wireless communications, comprising: one or more memories; and one or more processors, coupled to the one or more memories, configured to perform a method in accordance with any one of Clauses 1-12.

Clause 16: One or more apparatuses, comprising means for performing a method in accordance with any one of Clauses 1-12.

Clause 17: One or more non-transitory computer-readable media comprising executable instructions that, when executed by one or more processors of one or more apparatuses, cause the one or more apparatuses to perform a method in accordance with any one of Clauses 1-12.

Clause 18: One or more computer program products embodied on one or more computer-readable storage media comprising code for performing a method in accordance with any one of Clauses 1-12.

Clause 19: One or more apparatuses configured for wireless communications, comprising: a processing system that includes one or more processors and one or more memories coupled with the one or more processors, the processing system configured to cause the one or more apparatuses to perform a method in accordance with any one of Clauses 1-12.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. M any of these features may be combined in ways not specifically recited in the claims or disclosed in the specification. The disclosure of various aspects includes each dependent claim in combination with every other claim in the claim set.

What is claimed is:

1. An apparatus for wireless communications, comprising a processing system that includes one or more processors and one or more memories coupled with the one or more processors, the processing system configured to cause a wireless communications device to:
generate a randomized initial v-bit state in accordance with a randomization seed;
generate a sequence of v-bit states, each v-bit state in the sequence of v-bit states being generated in accordance with a respective set of k information bits in a sequence of sets of k information bits and in accordance with a respective preceding v-bit state in the sequence of v-bit states, except that a first v-bit state in the sequence of v-bit states is generated in accordance with a first set of k information bits in the sequence of sets of k information bits and the randomized initial v-bit state;
generate a sequence of c-bit values, each c-bit value of the sequence of c-bit values being generated in accordance with a pseudorandom number generator and a respective v-bit state in the sequence of v-bit states;
map the sequence of c-bit values to a sequence of sets of one or more constellation symbols; and
transmit one or more communications according to the sequence of sets of one or more constellation symbols.

2. The apparatus of claim 1, wherein the randomization seed is a randomization identifier configured for the wireless communications device, wherein the randomization identifier is a value configured specifically for use in generating the randomized initial v-bit state.

3. The apparatus of claim 2, wherein the processing system is further configured to cause the wireless communications device to receive a configuration indicating the randomization identifier.

4. The apparatus of claim 1, wherein the randomization seed comprises a scrambling identifier configured for the wireless communications device.

5. The apparatus of claim 1, wherein the randomization seed comprises a radio network temporary identifier (RNTI) configured for the wireless communications device.

6. The apparatus of claim 1, wherein the randomization seed comprises a cell identifier configured for the wireless communications device.

7. The apparatus of claim 1, wherein the processing system is further configured to cause the wireless communications device to:
receive an indication of a network-selected randomization seed, and
identify the randomization seed as the network-selected randomization seed.

8. The apparatus of claim 1, wherein to cause the wireless communications device to generate the randomized initial v-bit state, the processing system is configured to cause the wireless communications device to generate the randomized initial v-bit state further based on a code block index value associated with the sequence of sets of k information bits.

9. A method of wireless communication by a wireless communications device, comprising:
generating a randomized initial v-bit state in accordance with a randomization seed;
generating a sequence of v-bit states, each v-bit state in the sequence of v bit states being generated in accordance with a respective set of k information bits in a sequence of sets of k information bits and in accordance with a respective preceding v-bit state in the sequence of v-bit states, except that a first v-bit state in the sequence of v-bit states is generated in accordance with a first set of k information bits in the sequence of sets of k information bits and the randomized initial v-bit state;
generating a sequence of c-bit values, each c-bit value of the sequence of c-bit values being generated in accordance with a pseudorandom number generator and a respective v-bit state in the sequence of v-bit states;
mapping the sequence of c-bit values to a sequence of sets of one or more constellation symbols; and
transmitting one or more communications according to the sequence of sets of one or more constellation symbols.

10. The method of claim 9, wherein the randomization seed is a randomization identifier configured for the wireless communications device, wherein the randomization identifier is a value configured specifically for use in generating the randomized initial v-bit state.

11. The method of claim 10, further comprising receiving a configuration indicating the randomization identifier.

12. The method of claim 9, wherein the randomization seed comprises a scrambling identifier configured for the wireless communications device.

13. The method of claim 9, wherein the randomization seed comprises a radio network temporary identifier (RNTI) configured for the wireless communications device.

14. The method of claim 9, wherein the randomization seed comprises a cell identifier configured for the wireless communications device.

15. The method of claim 9, further comprising:
receiving an indication of a network-selected randomization seed, and
identifying the randomization seed as the network-selected randomization seed.

16. The method of claim 9, wherein generating the randomized initial v-bit state comprises generating the randomized initial v-bit state further based on a code block index value associated with the sequence of sets of k information bits.

17. An apparatus for wireless communications, comprising a processing system that includes one or more processors and one or more memories coupled with the one or more processors, the processing system configured to cause a wireless communications device to:
generate a plurality of sets of candidate constellation symbols based at least in part on a plurality of candidate randomization seeds,
wherein each set of candidate constellation symbols of the plurality of sets of candidate constellation symbols corresponds to a different candidate randomization seed of the plurality of candidate randomization seeds;
select a randomization seed, from the plurality of candidate randomization seeds, based at least in part on the plurality of sets of candidate constellation symbols; and
transmit an indication of the selected randomization seed.

18. The apparatus of claim 17, wherein the processing system is further configured to cause the wireless communications device to evaluate a performance of each candidate randomization seed, in the plurality of randomization seeds, based on a respective set of candidate symbols of the plurality of sets of candidate constellation symbols,
wherein to cause the wireless communications device to select the randomization seed, the processing system is configured to cause the wireless communications device to select the randomization seed based at least in part on a result of evaluating the performance of each candidate randomization seed.

19. The apparatus of claim 18, wherein to cause the wireless communications device to evaluate the performance of a candidate randomization seed of the plurality of candidate randomization seeds, the processing system is configured to cause the wireless communications device to evaluate the performance of the candidate randomization seed based on distances between constellation points associated with a candidate set of constellation symbols associated with the candidate randomization seed.

20. The apparatus of claim 18, wherein the performance of each candidate randomization seed is with respect to a current modulation and coding scheme (MCS) and a current slot.
